(19) United States
(12) Patent Application Publication
(10) Pub. No.: US 2016/0227695 A1
(43) Pub. Date: Aug. 11, 2016

(54) CULTIVATOR SHARE DEVICE

(71) Applicant: KVERNELAND GROUP OPERATIONS NORWAY AS, Kvernaland (NO)

(72) Inventor: Magne SKJÆVELAND, Klepp St. (NO)

(73) Assignee: KVERNELAND GROUP OPERATIONS NORWAY AS, Kvernaland (NO)

(21) Appl. No.: 15/021,378

(22) PCT Filed: Sep. 11, 2014
(86) PCT No.: PCT/NO2014/050166

§ 371 Date: Mar. 11, 2016

(30) Foreign Application Priority Data
Sep. 20, 2013 (NO) 20131264

(51) Int. Cl. A01B 15/06

(52) U.S. Cl. CPC A01B 15/06

(57) ABSTRACT

Cultivator share device (1) comprising a fastening portion (11) for fixing to a tine (2), a point (121) and divergent wings (13a, 13b) protruding backwards from the point (121) and a longitudinal ridge (122) extending from the point (121) and towards the fastening portion (11), the wings (13a, 13b) forming a leading wing edge (124a, 124b, 132a, 132b), wherein a front portion (12) formed by the point (121), a substantial portion of the longitudinal ridge (122) and front wing portions (123a, 123b) is deflected downwards such that, seen in the working direction of the cultivator point (1), there is an angle difference (a) between a plane congruent with the leading wing edges (132a, 132b) of rear wing portions (131a, 131b) and a plane congruent with the leading wing edges (124a, 124b) of front wing portions (123a, 123b).

The present invention relates to a cultivator share device comprising a fastening portion for fixing to a tine, a point and divergent wings projecting backwards from the point, and a longitudinal ridge extending from the point and towards the fastening portion, and the wings forming a leading wing edge.

A cultivator, i.e. a tine tool for cultivating a soil, is provided with a wear point provided with wings, and may for instance have a total width of 20-30 cm. When a cultivator share in accordance with prior art is adjusted such that the lower edge of the cultivator share is horizontal and therefore forms a planar, horizontal cut in the soil being cultivated, experience shows that with shallow working depth in hard, dry soil, problems will arise in making the tool descend to the pre-set working depth. If the cultivator is set with a steeper engagement angle of the cultivator shares, this will make a big difference about working depth between the point and the wing ends, which is disadvantageous for the effect one wishes to obtain by working the soil with the cultivator.

From DE 3628910 A1 a soil-working tine provided with a share with an exchangeable share tip and detachable wings, is known. The wings are securely bolted to a guide plate constituting the base for the share and the share tip and which protrudes from the edges of the share and the share tip. The wings give the share larger working width and may be removed if required.

US 2008257574 A1 discloses a cultivator tine provided with a symmetrical wing share mounted on a vertical, stiff tine. A sleeve-shaped body and a front tip are pushed onto a front, wedge-shaped portion of the tine. Holders for detachable wings protrude slantingly outwards and backwards from the body. The wings are attached to the body's protruding holders by means of screws or the like.

WO 0156360 A1 discloses a replaceable wear part for mounting on a leading edge of a working tool, the wear part and the leading edge having co-operative guide formations for quick coupling of the wear part to the working tool.

The invention has for its object to remedy or to reduce at least one of the drawbacks of the prior art, or at least to provide a useful alternative to the prior art.

The object is achieved through features, which are specified in the description below and in the claims that follow.

A wear point for a cultivator is provided, in the following named a cultivator share, comprising a fastening portion which for a symmetrical cultivator share is arranged with a longitudinal axis congruent with a vertical plane through the central axis of the cultivator share. The fastening portion may be formed with a quick coupling or with a screw fastening known per se. In the continuation of the tine fastening, a point is arranged. A right and a left wing extend slantingly backwards from the point. A front portion comprising the point and a front portion of the wings are, when a leading edge of a rear portion of the wings is horizontal, deflected slightly downwards, typically such that the point for all practical purposes and with the dimensions commonly used for cultivator points, is 10-20 mm below a plane congruent with the leading wing edge of the rear portions of the wings. This means that between said plane and a plane congruent with the leading wing edge of the front wing portions, there is a difference in angle seen in the working direction of the cultivator share, in the range of approximately 6-13°. In an advantageous embodiment, the difference in angles is approximately 10°.

In immediate proximity and behind the deflected front portion the cultivator share may be provided with a transverse ridge or elevation which provides a shelter effect for the fastening portion of the cultivator share with regards to the flow of soil which passes over the centre portion of the cultivator point.

More specifically, the invention relates to a cultivator share device comprising a fastening portion for fixing to a tine, a point and divergent wings protruding backwards from the point and a longitudinal ridge extending from the point and towards the fastening portion, the wings forming a leading wing edge, wherein a front portion formed by the point, a substantial portion of the longitudinal ridge and front wing portions is deflected downwards such that, seen in the working direction of the cultivator share, there is an angle difference between a plane congruent with the leading wing edges of rear wing portions and a plane congruent with the front wing edges of front wing portions; and the leading wing edges and their respective wing portions are continuous.

The angle difference may be in the range of 6-13°. Alternatively, the angle difference may be in the range of 9-11°.

The adjacent front portion may be arranged with a transversal ridge forming an ending to the longitudinal ridge.

The fastening portion may constitute part of a quick connection of the pin/socket type.

In the following is described an example of a preferred embodiment illustrated in the accompanying drawings, wherein:

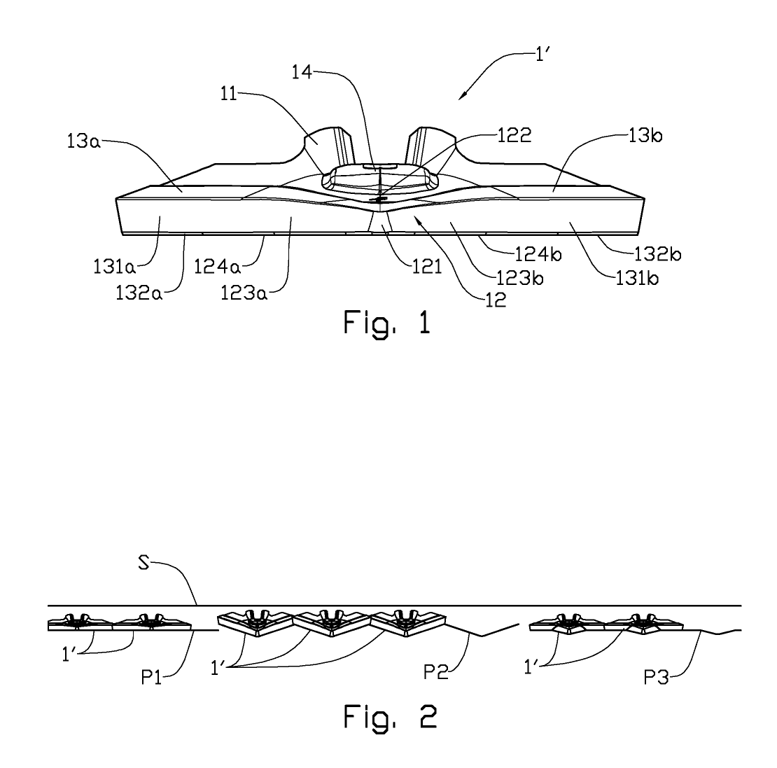

FIG. 1 shows a front elevation of a cultivator share in accordance with prior art, adjusted to a horizontal working cut;

FIG. 2 shows in a smaller scale a working plane for a plurality of cultivator shares placed side by side in accordance with prior art with normal and inclined adjustment, as well as for cultivator shares in accordance with the invention, placed side by side with a normal adjustment;

FIG. 3 shows in the same scale as FIG. 1, a side elevation of a cultivator share in accordance with the invention; and

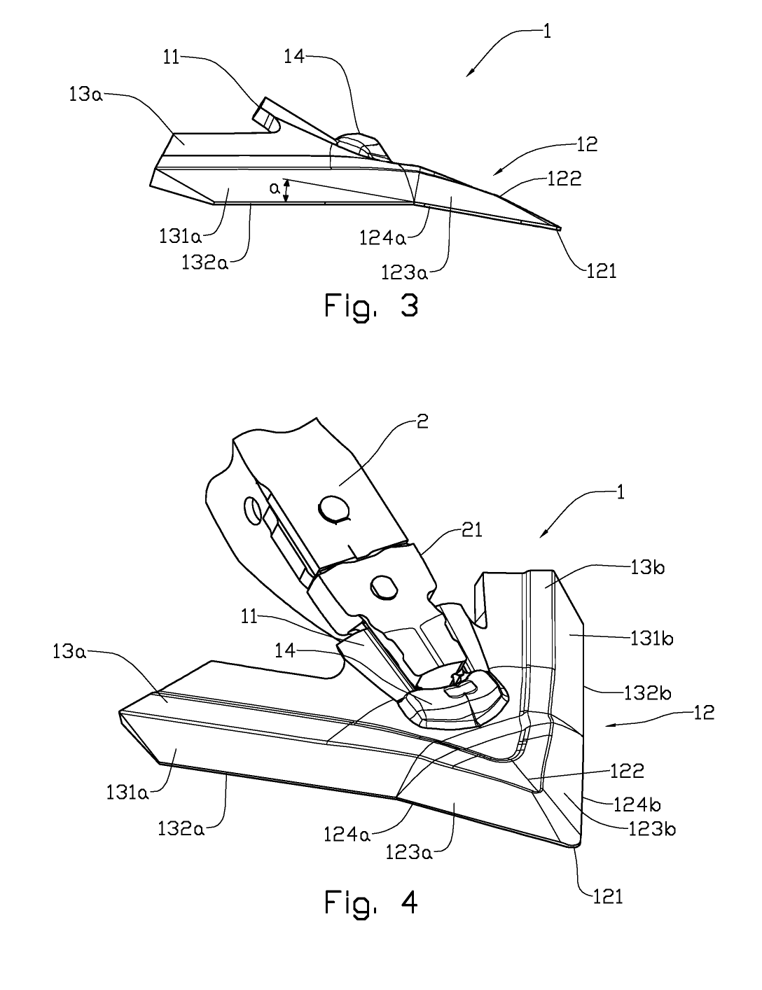

FIG. 4 shows a perspective sketch of the cultivator share in accordance with the invention.

Similar elements in the shown example of a cultivator share 1′ in accordance with prior art and the embodiment of the cultivator share 1 in accordance with the invention, have the same reference numbers.

Reference is first made to FIG. 1. On the cultivator share 1′ in accordance with prior art, there is a leading wing edge 124a, 124b on a front wing portion 123a, 123b in the same plane as a leading wing edge 132a, 132b on a rear wing portion 131a, 131b. With a normal adjustment of the cultivator share 1′ in accordance with prior art, a planar working plane P1 is formed, as shown in the left part of FIG. 2. When the ground engagement has to be increased and the cultivator share 1′ has to be inclined, as shown in the middle part of FIG. 2, an uneven, grooved working plane P2 is formed.

Reference is now made to FIGS. 3 and 4. A cultivator share 1 in accordance with the invention is provided with a fastening portion 11, here shown as a quick connection fastener. A front portion 12 comprises a point 121 and a longitudinal ridge 122 from which a right wing 13a and a left wing 13b protrude divergently outwardly from the point 121. Front wing portions 123a, 123b constitute parts of the front portion 12. Adjacent the fastening portion 11 a transversal ridge 14 is arranged, formed as a wear protection for the fastening portion 11.

Rear wing portions 131a, 131b, each provided with a leading wing edge 132a, 132b, form an extension of the wings 13a, 13b from the front wing portions 123a, 123b. The front portion 12 is slightly deflected downwards such that the point 121 lies below a plane congruent with front the wing edges 132a, 132b of the rear wing portions 131a, 131b. The angle difference α between said plane and a plane, which is congruent with the leading wing edges 124a, 124b of the front wing portions 123a, 123b, is in the range of 6-13°, on FIG. 3 shown as 10°.

The cultivator share 1 is fastened to a tine 2, see FIG. 4, here shown connected to a quick connection coupling 21.

The downwards deflection of the front portion 12 gives a desired ground engagement without letting the height difference between the point 121 and the rear end of the wings 13a, 13b, become unnecessary big. This creates a working plane P3 (see the right part of FIG. 2) with wide, planar portions and only narrow, shallow grooves.

1. Cultivator share device (1) comprising a fastening portion (11) for fixing to a tine (2), a point (121) and divergent wings (13a, 13b) protruding backwards from the point (121) and a longitudinal ridge (122) extending from the point (121) and towards the fastening portion (11), the wings (13a, 13b) forming a leading wing edge (124a, 124b, 132a, 132b), characterised in that
a front portion (12) formed by the point (121), a substantial portion of the longitudinal ridge (122) and front wing portions (123a, 123b) is deflected downwards such that, seen in the working direction of the cultivator share (1), there is an angle difference (α) between a plane congruent with the leading wing edges (132a, 132b) of rear wing portions (131a, 131b) and a plane congruent with the leading wing edges (124a, 124b) of front wing portions (123a, 123b); and
the leading wing edges (124a, 132a; 124b, 132b) and their respective wing portions (123a, 131a; 123b, 131b) are continuous.

2. Cultivator share device (1) in accordance with claim 1, wherein the angle difference (α) is in the range 6-13°.

3. Cultivator share device (1) in accordance with claim 1, wherein the angle difference (α) is in the range 9-11°.

4. Cultivator share device (1) in accordance with claim 1, wherein the adjacent front portion (12) is arranged with a transversal ridge (14) forming an ending to the longitudinal ridge (122).

5. Cultivator share device (1) in accordance with claim 1, wherein the fastening portion (11) constitutes part of a quick connection of the pin/socket type.
